(19) United States
(12) Patent Application Publication
(10) Pub. No.: US 2009/0151565 A1
(43) Pub. Date: Jun. 18, 2009

(54) METHOD AND APPARATUS FOR REDUCING WOOL PRODUCTION LINE EMISSIONS

(76) Inventors: Michael A. Tressler, Pickerington, OH (US); Donald R. Miller, Granvile, OH (US); Thomas I. Prosek, Pickerington, OH (US); Frank Kristie, Toledo, OH (US); Richard A. Jenne, Oregon, OH (US); William R. Cooper, Johnstown, OH (US)

Correspondence Address: OWENS CORNING, 2790 COLUMBUS ROAD, GRANVILLE, OH, 43023, US

(21) Appl. No.: 11/957,463

(22) Filed: Dec. 16, 2007

(51) Int. Cl. B01D 47/06; B01D 50/00

(52) U.S. Cl. 95/187; 55/315.1; 96/280; 95/206

(57) ABSTRACT

A scrubbing system for removing particulate from an air stream generated during a glass-wool insulation forming process includes a first separator system for removing at least a first portion of the particulate from the air stream, a second separator system, in the form of a single cloud generating vessel, for removing another portion of the particulate, and a third separator system for removing both moisture and a further portion of the particulate. The first separator system is designed to effectively provide a high residence or pre-treatment time for the air stream that enables fine particles to grow into larger particles which are easier to trap and collect, while also allowing the air stream ample time to cool to saturation temperatures. The first and third separator systems combine with the single cloud generating vessel to synergistically enhance the overall efficacy and efficiency of the scrubbing system.

### FIELD OF THE INVENTION

The present invention pertains to the art of glass-wool fiber insulation production and, more particularly, to a method and scrubbing apparatus for removing particulate pollutants from stack gases generated during the production of glass fiber wool-type insulation products.

### BACKGROUND

During the manufacture of glass fiber wool-type insulation products, molten glass from a refining tank flows into equipment which physically forms the molten glass into fibers which are sprayed with a curable organic resin binder. The binder coated glass fibers are then formed into a pack or mat via deposition onto a foraminous belt. The foraminous belt conveys the glass fiber/resin mixture through a curing oven during which time the resin hardens to create a wool-like insulation product.

Located beneath the foraminous belt is an air intake. The air intake receives a gas flow that penetrates through the formed pack of fibers and the foraminous belt. The gas flow is composed of natural gas combustion products, along with compressed and induced air exhausted from the fiber forming equipment, evaporated water, compressed and induced air that is used to distribute the glass fibers onto the foraminous belt and inducted factory air that serves to contain the falling resin/fiber mixture within the glass fiber pack/mat forming apparatus. The gas flow ultimately passes through a vertical exhaust stack and is discharged into ambient atmosphere. Prior to being discharged, the air flow passes through a scrubber system that removes foreign particles developed during the glass wool fiber and pack/mat forming process.

In general, most known scrubber systems employ water droplet impaction, gravity settling, cyclonic separation or barrier impaction to sequentially cause larger, and then smaller, particles to be removed from the air flow. Another known system constitutes a wet electrostatic precipitator or WEP that can be used to capture particles which have Is passed through a preceding device. In a WEP, the particulate is ionized via an electrode created corona discharge. The ionized particulate is then collected on a positively charged wall located within the WEP. While considered effective, the WEP is a very high capital and operating cost component that consumes additional energy during operation.

Certainly, other emission reducing systems exist in other product manufacturing fields. One such known arrangement is constituted by a cloud chamber system that employs a pre-conditioning chamber (PCC) and a set of cloud generating vessels (CGV's) to remove particles from an air flow. While in the PCC, coarse particles are removed and many ultra fine particles are grown to larger particles. The PCC also allows the air stream to cool to the saturation point. From the PCC, the air stream passes through a demister and then into the CGV's. In the first CGV, the air stream mixes with a cloud of positively or negatively charged water droplets and, in the second CGV, the air stream mixes with a cloud of water droplets which are charged oppositely than those in the first CGV. Neutrally charged particles contained within the air stream are attracted to the positively and negatively charged water droplets and captured. After treatment in the cloud chamber system, the air flow is passed to a demister which removes remaining moisture.

In connection with the present invention, a need has been recognized for an enhanced apparatus and method for removing fine particulate pollutants from stack gases generated during the production of glass-wool fiber insulation. More specifically, a need has been recognized for an energy efficient, cost effective, particulate removal system having multiple stages that synergistically operate to reduce line emissions in the field of fiberglass wool insulation production.

### SUMMARY OF THE INVENTION

The present invention is directed to a scrubbing apparatus for removing particulate from an air stream generated during a glass-wool insulation fiber and pack/mat forming process. The apparatus includes an air duct that guides an air stream containing glass-wool particulate away from a glass-wool insulation fiber and pack/mat forming apparatus, a first separator system, established by a series of chambers and separators, for removing a first portion of the particulate from the air stream and for providing cooling, humidification and residence time to promote the growth and agglomeration of smaller particles into larger particles, a second separator system in the form of a single cloud generating vessel (CGV) employed to remove a second portion of the particulate, and a third separator system for both removing moisture and a third portion of the particulate from the air stream.

In accordance with the invention, the first separator system effectively provides ample time for the air stream to cool to saturation temperatures, become humidified and be stripped of larger particulates, while also affording a high residence or pre-treatment time that enables fine particles to grow into larger particles. In accordance with the invention, the first separator system can take various forms, including:
a drop-out box with water sprays followed by a baffle type mist eliminator referred to as a penthouse,
a drop-out box with water sprays followed by a vortex baffle mist eliminator,
a wetted wall exhaust duct,
a wetted wall exhaust duct followed by a cyclonic wet scrubber,
a drop-out box with water sprays followed by a cyclonic wet scrubber,
a wetted wall exhaust duct followed by a tangential bottom entry primary separator,
a drop-out box with water sprays followed by a cyclonic separator,
a drop-out box with water sprays followed by a wet scrubber and a pad type mist eliminator,
a drop-out box with water sprays followed by a venturi scrubber and a tangential bottom entry primary separator, or
another series of separating devices that are functionally equivalent in terms of residence time, humidification and particle removal.
   Where water is employed in connection with the first separator system, the respective separator will include a water inlet for receiving a flow of water that aides in separating out particulate. In addition, each of the second and third separator components which use water includes a drain line leading to a gray water reservoir. Water in the recycled water reservoir is re-used in the glass-wool insulation forming process, while the water in the gray water reservoir is either filtered and recycled, or further treated and stored, for use in other parts of the process.

In any case, the air stream emanating from the first separator system is directed to the single CGV for further particulate separation. By providing sufficient time for the fine particles to grow into larger particles in the first separator system, the overall efficacy and efficiency of the single CGV cloud generating chamber is significantly improved. Downstream of the CGV is the third separator system which functions to remove both moisture and another portion of the particulate prior to exhausting of the air stream. The use of the first separator system in combination with the single CGV and the third or downstream separator system has been found to have a synergistic effect in reducing fiberglass wool insulation production line emissions such that an extremely effective and efficient overall production control arrangement is established.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a schematic view of an apparatus for removing particulate from an air stream generated during operation of a glass-wool insulation fiber and pack/mat forming system constructed in accordance with a first embodiment of the invention;

FIG. 2 is a schematic view of an apparatus for removing particulate from an air stream generated during operation of a glass-wool insulation fiber and pack/mat forming system constructed in accordance with a second embodiment of the invention; and

FIG. 3 is a more schematic and generic view of an apparatus for removing particulate from an air stream generated during operation of a glass-wool insulation fiber and pack/mat forming system constructed in accordance with the invention.

### DETAILED DESCRIPTION OF THE PREFERRED EMBODIMENTS

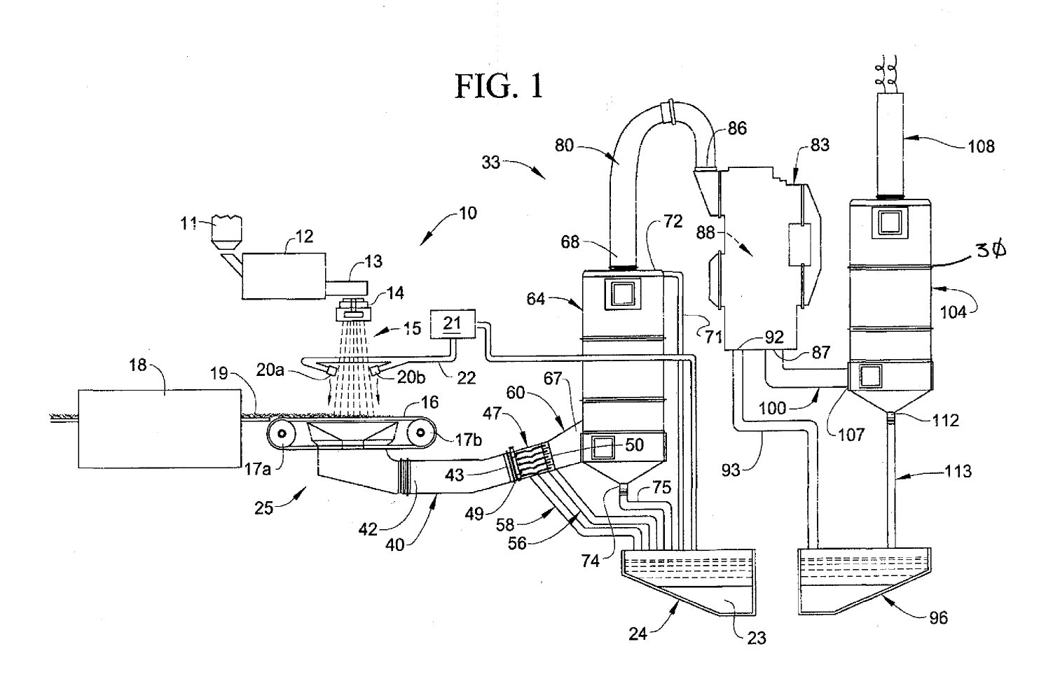

With initial reference to FIG. 1, reference numeral 10 generally refers to a system for producing glass-wool fiber type material such as used in thermal insulation products and the like. Glass-wool forming system 10 includes a batch hopper 11 which discharges glass into a melting and refining tank 12 having a forehearth 13. Molten glass issuing from forehearth 13 passes through a centrifugal forming means 14 which outputs a stream of glass fibers 15 that fall, gravitationally, onto a foraminous forming conveyor 16 that extends about a pair of guide drums 17a and 17b. Forming conveyor 16 is arranged adjacent to a curing oven 18 through which the glass fibers 15, in the form of a pack/mat 19 of glass fibers 15, are sent. Prior to coming to rest on forming conveyor 16, glass fibers 15 are coated with a resin or binding material issuing from spray nozzles 20a and 20b, while being exposed to an induced airflow (not shown). More specifically, nozzles 20a and 20b discharge an organic resinous binder, such as one formulated from a phenol formaldehyde resin, onto glass fibers 15 falling onto forming conveyor 16. The binder passes from a binder preparation system 21, having associated tanks (not shown), into a spray nozzle conduit 22. The binder is formulated using wash water 23 pumped from a recycled water reservoir 24 prior to reaching and being discharged through nozzles 20a and 20b.

As will become more fully evident below, the present invention can take various forms and employ certain variations in construction without departing from the invention. In the embodiment depicted in FIG. 1, a collection hopper 25 for collecting glass-wool and other physical/chemical forms of particulate is located beneath forming conveyor 16. More specifically, during operation, an air flow, generated by a fan 30 draws glass fibers 15 onto forming conveyor 16. The created air stream draws stray particulates passing through and around forming conveyor 16 into collection hopper 25. Prior to being discharged to ambient atmosphere, the air stream must be guided through a scrubbing apparatus 33 in order to remove the particulate.

In accordance with this first embodiment of the invention, scrubbing apparatus 33 includes an air duct 40 having a first end portion 42 which is fluidly connected to collection hopper 25 through fan 30 and extends to a second end portion 43. Second end portion 43 is connected to a first separator 47 which, in accordance with the first embodiment of the present invention, is constituted by a venturi scrubber forming part of a first separator system. Venturi scrubber 47 includes an inlet portion 49 for receiving the particulate laden air stream and an outlet portion 50. In addition, venturi scrubber 47 includes a water inlet 56 which receives a pressurized water flow that mixes with the air stream to moisten any particulate contained therein. While in venturi scrubber 47, a first portion or larger particles are trapped and collected, while finer particles collide and grow into larger particles. In any case, venturi scrubber 47 is also shown to include a drain 58 which leads back to recycled water reservoir 24. After being treated in venturi scrubber 47, the air stream laden with moist particulate, enters into an air duct 60 and passes into a second separator 64 of the first separator system.

In further accordance with the embodiment shown, second separator 64 is constituted by a cyclone separator, of a type known in the art, having an inlet portion 67 that receives the air stream laden with moistened particulate and an outlet portion 68. Cyclone separator 64 is further shown to include in some cases a water inlet conduit 71 which is connected to a nozzle ring 72 that is positioned adjacent outlet portion 68 or inlet portion 67. Nozzle ring 72 preferably includes ten to twelve water nozzles (not shown) that provide a water spray within cyclone separator 64 that facilitates the capture of another portion of the particulate. More specifically, whether water sprays systems depicted by 71 and 72 are included or not included, the cyclonic environment forces larger particles to fall along inner wall portions of cyclone separator 64, while allowing smaller particulates to exit through outlet portion 68. In addition, while in cyclone separator 64, fine particles adhere to one another and grow into even larger particles. Cyclone separator 64 is also shown to include a drain 74 that allows water flowing from second separator 64 to pass through a drain conduit 75 into recycled water reservoir 24. Water 23 typically only includes larger particles which can be readily removed through a simple filtering process. With this arrangement, a high percentage of water utilized in the overall glass-wool forming process can be readily re-used. In any case, by passing the particulate laden air stream through first and second separators 47 and 64, not only does the air stream cool to saturation temperatures, but the particles are provided a high residence time prior to entering a duct 80 for passage to a third separator 83 which captures yet another portion of the particulate. As noted above, the higher residence time enables an extremely large portion of the ultra fine particles, in the order of the size of a few hundredths of a micron, to grow in size, such as to a few tenths of a micron, thereby facilitating their removal from the air stream.

As noted above, the air stream passes from second separator 64 through duct 80 into third separator 83 which, in accordance with the present embodiment, is part of a second separator system and constituted by a single cloud generating vessel having an inlet portion 86, an outlet portion 87 and an interior chamber 88. The overall operation of cloud generating vessel 83 is known in other fields as discussed above and therefore will not be described in detail herein. However, in broad terms, while in interior chamber 88, particles are attracted to droplets of water and captured through monopole induced dipole charging effects. In accordance with the invention, either positive or negative charges are associated with the operation of cloud generating vessel 83. The cloud generating vessel defining third separator 83 can take various forms, such as a cloud generating vessel produced by the TRI-MER Corporation. After the particulate is captured within cloud generating vessel 83, the air stream passes through outlet portion 87. Residual moisture containing captured particles remaining within interior chamber 8 is directed through a drain 92 which leads to a drain conduit 93 that empties into a gray water reservoir 96. More specifically, the portion of the particulate separated out by cloud generating vessel 83 contains high percentages of cured or advanced binding material or resin. Towards that end, any moisture accumulated within interior chamber 88 and discharged through drain 92 likewise contains a high percentage of cured or advanced resin and thus is preferably not recycled back through the glass-wool fiber forming process. Any water contained within gray water reservoir 96 can be readily treated and discharged or, treated, retained and stored to address local environmental regulations. The air stream passes from outlet portion 87 into a duct 100 to a fourth separator 104 of a third separator system which removes entrained moisture and yet another portion of the particulate.

In accordance with the embodiment shown, separator 104 is constituted by a cyclone separator/demister having an inlet portion 107 for receiving the moisture laden air flow having a very low particulate content, and an outlet or stack portion 108 which leads to ambient atmosphere. Cyclone separator/demister 104 removes a majority of any remaining particulate from the air stream along with a majority of the moisture. Moisture is directed to a drain 112 through a discharge conduit 113 into gray water reservoir 96. As noted above, moisture removed from the air stream at this point in scrubbing system 33 contains relatively high levels of resin and therefore is not preferably re-used in the fiberglass insulation process. However, the air stream, now substantially free from particulate, is passed from cyclone separator/demister 104 to ambient atmosphere.

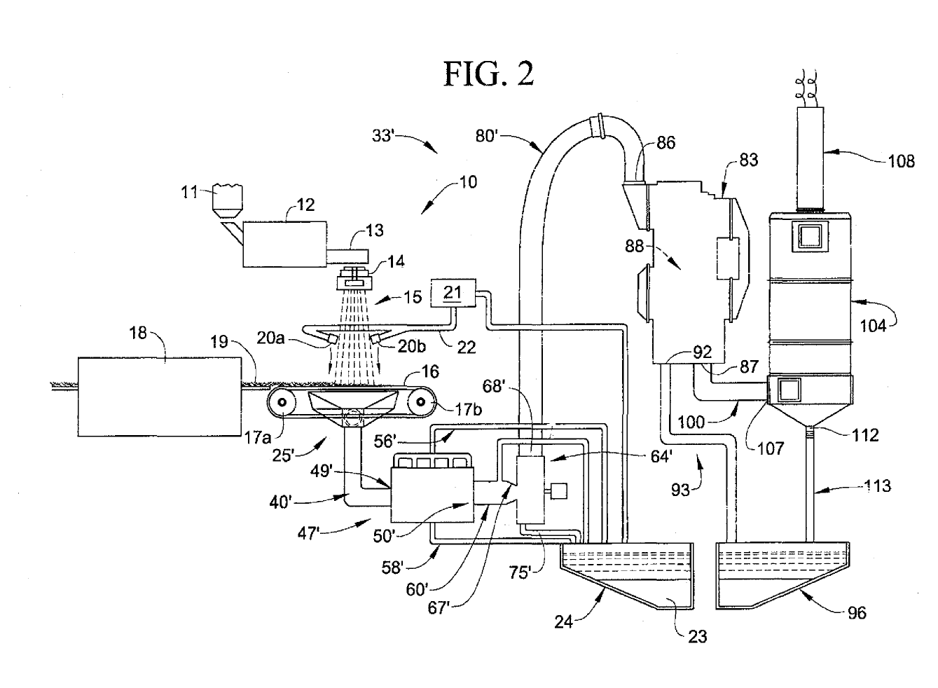

Reference will now be made to FIG. 2, where like reference numbers represent corresponding parts in the respective views, in describing a scrubbing system 33′ constructed in accordance with a second embodiment of the present invention. In general, the glass-wool insulation forming process of the second embodiment is identical to that described above with respect to the first embodiment and therefore will not be reiterated here. To this end, a particulate laden air stream is directed through a collection hopper 25′ into a first air duct 40′ to a first separator 47′.

However, in accordance with this embodiment, first separator 47′ is constituted by a drop-out box having an inlet portion 49′ and an outlet portion 50′. In addition, the drop-out box or first separator 47′ is provided with a water inlet 56′ and a drain 58′. More specifically, water 23 from reservoir 24 is directed, under pressure from a pump (not shown), through water inlet 56′ and sprayed into drop-out box 47′ to trap and collect a first portion of the particulate from the air stream. From drop-out box 47′, the air stream passes through an air duct 60′ to a second separator 64′ where another portion of the particulate is removed.

Second separator 64′ is constituted by a cyclonic vortex or chevron baffle separator having an inlet portion 67′ for receiving the air stream from first separator 47′ and an outlet portion 68′. More specifically, particulate laden water from first separator 47′ is removed from the airstream that enters second separator 64′. At this point, residual water returns, via a drain conduit 75, to reservoir 24 and the air stream is passed through an air duct 80′ to the third separator which is defined by cloud generating vessel 83. After entering cloud generating vessel 83, the process directly corresponds to that described above with respect to scrubbing system 33 of the first embodiment and will not be described in further detail.

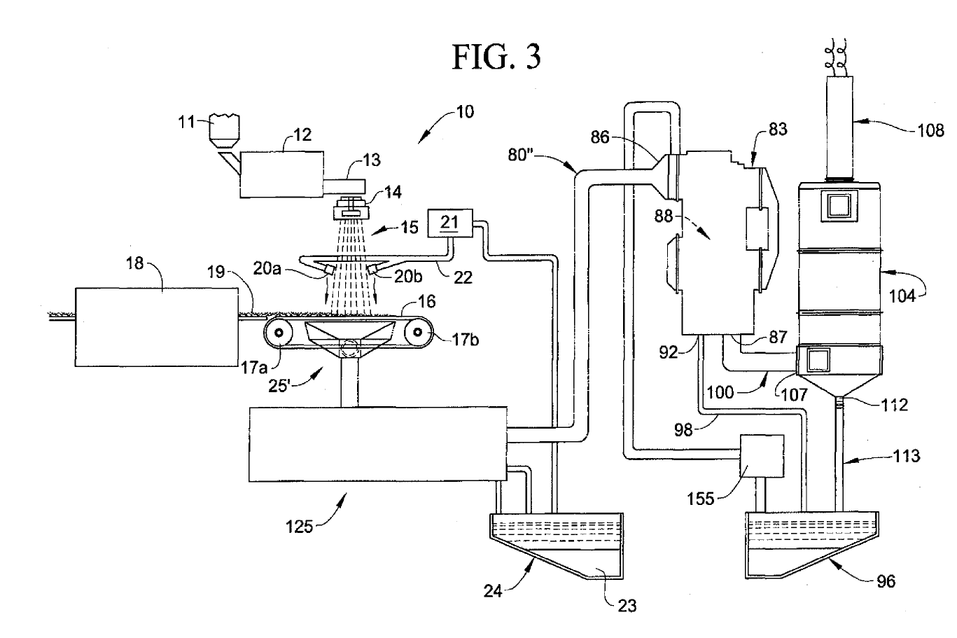

As indicated above, the overall scrubber system can take various forms, particularly in connection with the structure and operation of the one or more separators arranged upstream of the cloud generating vessel. FIG. 3 more generically represents the overall glass-wool insulation forming system 10 by broadly representing the first separator system as 125. In addition, FIG. 3 illustrates the potential positioning of a water filter unit 155 between gray water reservoir 96 and cloud generating vessel 83. As shown, first separator system 125 is arranged in fluid communication between collection hopper 25 or 25′ and cloud generating vessel 83, and linked to recycle water reservoir 24 through supply and drain lines (not separately labeled in this figure). In general, in accordance with the invention, the first separator system 125, i.e., the separator structure upstream of the second separator system defined by the cloud chamber vessel, can take various forms, including:
a drop-out box with water sprays followed by a baffle type mist eliminator referred to as a penthouse,
a drop-out box with water sprays followed by a vortex baffle mist eliminator,
a wetted wall exhaust duct,
a wetted wall exhaust duct followed by a cyclonic wet scrubber,
a drop-out box with water sprays followed by a cyclonic wet scrubber,
a wetted wall exhaust duct followed by a tangential bottom entry primary separator,
a drop-out box with water sprays followed by a cyclonic separator,
a drop-out box with water sprays followed by a wet scrubber and a pad type mist eliminator,
a drop-out box with water sprays followed by a venturi scrubber and a tangential bottom entry primary separator, or
another series of separating devices that are functionally equivalent in terms of residence time, humidification and particle removal.

It is important to note that the pre-cloud generating vessel separator(s), e.g., first and second separators 47′ and 67′, as with first and second separators 47 and 67, not only provide ample time for the air stream to cool to saturation temperatures but also provide a high residence time that facilitates the growth of ultra-fine particles into larger particles before the air stream enters the cloud generating vessel. By providing a high residence time to facilitate particle growth, the scrubbing system of the present invention surprisingly raises the overall efficiency and efficacy of cloud generating vessel 83 thereby ensuring that any air stream exiting to ambient atmosphere exceeds local and Federal environmental regulations. That is, the multiple separators operate synergistically to not only ensure compliance with present regulations but also looks to the future for compliance with potential newer, more strict regulations.

Incorporating a cloud generating vessel into the overall scrubbing apparatus of the present invention not only reduces capital costs, e.g., the single cloud generating vessel is considerably less expensive than a wet electrostatic precipitator (WEP), but also enables the scrubbing apparatus to operate in a more energy and operationally efficient manner. That is, the overall scrubbing apparatus of the present invention has been found to significantly reduce energy consumption, i.e., by as much as 60%, over presently employed systems. Furthermore, by directing process water from the first and second separators into a recycled water reservoir, and the process water from the third and fourth separators into a separate gray water reservoir, a higher percentage of process water can be efficiently re-used in the overall glass-wool forming process.

Although described with reference to preferred embodiments of the invention, it should be readily understood that various changes and/or modifications can be made to the invention without departing from the spirit thereof. In general, the invention is only intended to be limited by the scope of the following claims.

I/we claim:

1. An apparatus for treating a particulate laden air stream generated during a glass-wool insulation forming process comprising:
an air duct for guiding an air stream containing particulate away from a glass-wool forming apparatus;
a first separator system including an inlet portion connected to the air duct so as to receive the air stream and an outlet portion, said first separator system removing at least a first portion of the particulate from the air stream between the inlet portion and the outlet portion, said first separator system further retaining the air stream in order to provide ample time for the air stream to cool to saturation temperatures, while also providing a high residence time that facilitates the growth of ultra-fine particles into larger particles;
a second separator system in the form of a single cloud generating vessel including an inlet connected to the outlet of the first separator system and an outlet, said cloud generating vessel removing another portion of the particulate from the air stream; and
a third separator system including an inlet connected to the outlet of the cloud generating vessel and an outlet leading to ambient atmosphere, said third separator system removing moisture and a further portion of the particulate from the air stream prior to the air stream entering the ambient atmosphere.

2. The apparatus according to claim 1, wherein the first separator system includes a water inlet for receiving a flow of water, and a drain.

3. The apparatus according to claim 2, further comprising: a recycled water reservoir fluidly connected to the drain of the first separator system, said recycled water reservoir providing recycled water to at least a portion of the first separator system.

4. The apparatus according to claim 1, wherein each of the cloud generating vessel and the third separator system includes a water drain.

5. The apparatus according to claim 4, further comprising: a gray water reservoir fluidly connected to the water drain of both the cloud generating vessel and the third separator system.

6. The apparatus according to claim 1, wherein the first separator system is selected from the group of:
a drop-out box with water sprays followed by a baffle type mist eliminator;
a drop-out box with water sprays followed by a vortex baffle mist eliminator;
a wetted wall exhaust duct;
a wetted wall exhaust duct followed by a cyclonic wet scrubber;
a drop-out box with water sprays followed by a cyclonic wet scrubber;
a wetted wall exhaust duct followed by a tangential bottom entry primary separator;
a drop-out box with water sprays followed by a cyclonic separator;
a drop-out box with water sprays followed by a wet scrubber and a pad type mist eliminator;
a drop-out box with water sprays followed by a venturi scrubber and a tangential bottom entry primary separator, or
another series of separating devices that are functionally equivalent in terms of residence time, humidification and particle removal.

7. The apparatus according to claim 1, wherein the first separator system includes at least first and second separators which are in fluid communication.

8. The apparatus according to claim 7, wherein the first separator constitutes a drop-out box.

9. The apparatus according to claim 8, wherein the second separator is a cyclone separator.

10. The apparatus according to claim 7, wherein the first separator constitutes a venturi separator.

11. The apparatus according to claim 10, wherein the second separator is a vortex separator.

12. The apparatus according to claim 1, wherein the third separator system includes a demister.

13. The apparatus according to claim 12, wherein the third separator system includes a cyclone separator.

14. A method of reducing fiberglass wool insulation production line emissions by removing particulate from an air stream generated during a glass-wool insulation forming operation comprising:
passing an air stream containing particulate through a duct to a first separator system;
removing at least a first portion of the particulate from the air stream in the first separator system, with the air stream being retained in the first separator system for a time period enabling the air stream to cool to saturation temperatures, while also providing a high residence time that facilitates the growth of ultra-fine particles into larger particles;
passing the air stream from the first separator system to a second separator system defined by a single cloud generating vessel;
removing another portion of particles from the air stream in the cloud generating vessel;
passing the air stream directly from the cloud generating vessel to a third separator system;
removing a further portion of the particulate from the air stream in the third separator system; and
passing the air stream to ambient atmosphere.

15. The method of claim 14, further comprising: injecting water into the first separator system.

16. The method of claim 15, further comprising: draining the water from the first separator system into a recycled water reservoir.

17. The method of claim 16, further comprising: providing the water to the first separator system from the recycled water reservoir.

18. The method of claim 16, further comprising: draining water from the second and third separator systems into a gray water reservoir which is separate from the recycled water reservoir.

19. The method of claim 14, further comprising: removing at least the first portion of the particulate from the air stream in the first separator system selected from the group of:
a drop-out box with water sprays followed by a baffle type mist eliminator;
a drop-out box with water sprays followed by a vortex baffle mist eliminator;
a wetted wall exhaust duct;
a wetted wall exhaust duct followed by a cyclonic wet scrubber;
a drop-out box with water sprays followed by a cyclonic wet scrubber;
a wetted wall exhaust duct followed by a tangential bottom entry primary separator;
a drop-out box with water sprays followed by a cyclonic separator;
a drop-out box with water sprays followed by a wet scrubber and a pad type mist eliminator,
a drop-out box with water sprays followed by a venturi scrubber and a tangential bottom entry primary separator.

20. The method of claim 14, further comprising: subjecting the air stream to cyclone separation and demisting in the third separator system.
